(19) United States
(12) Patent Application Publication
(10) Pub. No.: US 2019/0258054 A1
(43) Pub. Date: Aug. 22, 2019

(54) OPTICAL APPROACH TO OVERCOMING VERGENCE-ACCOMMODATION CONFLICT

(71) Applicant: University of Rochester, Rochester, NY (US)

(72) Inventor: Geunyoung Yoon, Pittsford, NY (US)

(21) Appl. No.: 16/273,654

(22) Filed: Feb. 12, 2019

Related U.S. Application Data
(60) Provisional application No. 62/632,482, filed on Feb. 20, 2018.

(51) Int. Cl. G02B 27/00; G02B 27/01; G06T 19/00

(52) U.S. Cl. CPC G02B 27/0075; G02B 27/0101; G02B 2027/0178; G02B 27/0172; G06T 19/006

(57) ABSTRACT

A method for reducing vergence-accommodation conflict includes: modifying a depth of focus of each of an observer's eyes by use of at least one ocular device to be greater than the observer's uncorrected or corrected vision depth of focus to cause a combined vision from both eyes of the observer to provide a substantially in focus image to the observer of a virtual reality (VR) or augmented reality display (AR) screen at about a fixed distance from the observer. A device for reducing vergence-accommodation conflict is also described.

### CROSS-REFERENCE TO RELATED APPLICATIONS

This application claims priority to and the benefit of co-pending U.S. provisional patent application Ser. No. 62/632,482, OPTICAL APPROACH TO OVERCOMING VERGENCE-ACCOMMODATION CONFLICT, filed Feb. 20, 2018, which application is incorporated herein by reference in its entirety.

### FIELD OF THE APPLICATION

The application relates to virtual reality (VR) and augmented reality (AR) methods and devices and in particular to display screens at a fixed distance from a VR or AR observer's eyes.

### BACKGROUND

Virtual reality (VR) and augmented reality (AR) methods and devices create depth perceptions of objects at distances which are different from the fixed distance between an observer's eyes and a display screen. This mismatch can cause visual discomfort, headaches, and fatigue, as well as reduced stereo performance for the viewer, a critical problem known as “vergence-accommodation conflict”.

### SUMMARY

According to one aspect, a method for reducing vergence-accommodation conflict includes: modifying a depth of focus of each of an observer's eyes by use of at least one ocular device to be greater than the observer's uncorrected or corrected vision depth of focus to cause a combined vision from both eyes of the observer to provide a substantially in focus image to the observer of a virtual reality (VR) or augmented reality display (AR) screen at about a fixed distance from the observer.

The step of modifying can include modifying a depth of focus of each of an observer's eyes to be greater than the observer's uncorrected or corrected vision depth of focus by between about 1.0 Diopter and 4.0 Diopter.

The step of modifying can include modifying a depth of focus of each of an observer's eyes by use of at least one ocular device, so that the depth of focus is greater than the observer's uncorrected or corrected vision depth of focus to cause a combined vision from both eyes of the observer to provide a vergence—accommodation relationship similar to a natural viewing condition, which reduces at least a mismatch or a conflict.

The step of modifying a depth of focus can include modifying a depth of focus of each of an observer's eyes greater than the observer's uncorrected or corrected vision depth of focus by introduction of an aberration or a multifocal modification.

The introduction of an aberration can include an introduction of a spherical refractive error or a cylindrical refractive error. The introduction of an aberration can include of an aberration includes an introduction of a higher order aberration. The introduction of an aberration can include a pin hole or a small aperture between about 0.5 mm to 3 mm in diameter.

The step of modifying a depth of focus can include modifying a depth of focus of each of an observer's eyes greater than the observer's uncorrected or corrected vision depth of focus by introduction of a refractive error correction.

The refractive error correction can include a near vision correction for one eye, and a far vision correction for a different eye.

According to another aspect, a device for reducing vergence-accommodation conflict include a support structure adapted to house a virtual reality (VR) or augmented reality display (AR) display screen at a distance from an observer's first and second eyes. A first ocular device is adapted to cause a first extended depth of focus between the first eye of an observer and the display screen. The first ocular device is physically attached to the support structure or adapted to be worn by an observer as a contact lens or as a first lens of an eyeglass frame. A second ocular device is adapted to cause a second extended depth of focus between the second eye of an observer and the display screen. The second ocular device is physically attached to the support structure or adapted to be worn by an observer as a contact lens or as a first lens of an eyeglass frame. A combined vision from both eyes of the observer provides a substantially in focus image to the observer of the display screen at about a fixed distance from the observer.

The first extended depth of focus and the second extended depth of focus can be greater than the observer's uncorrected or the observer's corrected vision depth of focus by between about 1.0 Diopter and 4.0 Diopter.

The support structure can include a virtual reality wearable body or an augmented reality wearable body.

The support structure can include a goggles body adapted to fit an observer's face.

The at least one of the first ocular device or the second ocular device can include a spherical aberration correction.

The at least one of the first ocular device or the second ocular device can include a lens for correcting an ocular higher order aberration (HOA). The at least one of the first ocular device or the second ocular device can include an optical lens. The at least one of the first ocular device or the second ocular device can include a wavefront-guided scleral lens. The at least one of the first ocular device or the second ocular device can include a scleral lens prosthetic device (SLPD). The at least one of the first ocular device or the second ocular device can include a contact lens or a soft contact lens. The at least one of the first ocular device or the second ocular device can include a contact lens or a soft contact lens. The at least one of the contact lens or a soft contact lens can include a pin hole a small aperture between about 0.5 mm to 3 mm in diameter. The first ocular device and the second ocular device can include a right and left lens of an eyeglass frame.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 shows a drawing of one exemplary embodiment of a binocular adaptive optics vision simulator;

FIG. 2 is a drawing which shows how a series of eye chart “E” characters would appear to an observer's eye at relative distance from beyond infinity to near on a relative distance scale; and

FIG. 3 is another exemplary drawing of two rows of eye chart E symbols where there is a different depth of field for the left eye and the right eye as well as a line representing a combined binocular vision;

FIG. 4 is a drawing of an exemplary device according to the Application; and

FIG. 5 is a bar graph showing the results of the test and verification experiments.

### DETAILED DESCRIPTION

In the description, other than the bolded paragraph numbers, non-bolded square brackets (“[ ]”) refer to the citations listed hereinbelow.

Three-dimensional (3D) displays typically present images on a single surface i.e. at a fixed distance from the eyes. However, for an observer's visual system to achieve 3D perception, the displays need to be virtually at different distances. Placing the displays at different virtual distances causes a mismatched requirement of convergence and accommodation. Convergence is the eye rotation to fuse the two monocular images. Accommodation is the eye's optical power change to minimize image blur. The mismatch of convergence and accommodation can cause visual discomfort, headaches, and fatigue, and reduced stereo performance for the viewer, a critical problem known as “vergence-accommodation conflict” in the field of VR/AR technology.

The Application describes a solution to the vergence-accommodation conflict problem, a new method and device as an optical approach to overcoming, or at least reducing, this conflict. The method of the Application, without significantly sacrificing binocularly perceived retinal image quality, creates a visual situation optically where each of the two eyes has the same or different accommodative demands, where the accommodative demands are different from an uncorrected vision or a normal correction for normal vision, by using a new extended depth of focus technology. In some embodiments, the two eyes are optimized for two difference object distances, for example, one eye for “distance vision”, and the other eye for “near vision”. Accommodative responses are thus determined by the eye that has better retinal image quality at each object distance resulting in less accommodation demand.

The method has been tested by use of a state-of-art binocular adaptive optics (AO) vision simulator which includes two functions, ocular aberration sensing (a wavefront sensor) and controlling (deformable mirror). This apparatus enables us to objectively measure binocular accommodation response to dissimilar monocular visual inputs induced by the inter-ocular difference in optical quality manipulated by the deformable mirror. The same system can also be used to perform psychophysical testing of depth perception as well as subjective visual symptoms. Results from such studies have provided useful information regarding the feasibility of the new devices and methods of the Application for correcting the vergence-accommodation conflict.

Parts of the Application—In the description which follows, there are 7 parts. Part 1 is an overview. Part 2 provides describes the new method and device. Part 3 describes exemplary devices. Part 4 describes exemplary laboratory experiments suitable to investigate aspects of the method and device of the Application. Part 5 describes traditional monovision and modified monovision. Part 6 is a summary Part 7 describes verification of the new devices and methods with human subjects.

### Part 1—Introduction

Vergence-accommodation conflict causes visual fatigue and reduced stereo performance. As the eye accommodates to near objects, pupil size decreases, the two eyes converge to maintain binocular fusion, and the eyes' optical power is increased to sharpen the retinal image quality. These three processes (pupil size, binocular fusion, and optical power) are commonly referred to as the accommodative triad.

Under natural viewing conditions, accommodation and convergence are highly correlated to form a binocularly stable, clear percept. However, in a VR/AR environment, in which three-dimensional displays typically present images on a single surface, i.e. at the fixed distance from the eyes, typically uses one or two displays (e.g. one display can show two images, such as, for example, by use of a single wide display which shows a first image on one side of the display to be viewed by the left eye of the user, and a second image on an opposite side of the same display to be viewed by the right eye of the user), where the left and right images are virtually at different distances for the visual system display or displays, to achieve 3D perception. It has been found that this mismatch of different virtual distances, vergence-accommodation conflict, causes visual fatigue [1] and unstable accommodative response [2] for the viewer, leading to significantly reduced stereoacuity [3]. This conflict occurs in all commercially available 3-D displays and has been identified as one of the most critical problems limiting performance of current VR/AR technology. Although in principle, these problems could be resolved if a stereo display could adjust the focal distance to each point in the scene to match the simulated distance, proposed hardware solutions under investigations for feasibility assessment [4,5] are still bulky and heavy for a wearable device and the scene is restricted.

In previous work, such as was described in binocular visual performance and summation after correcting higher order aberrations [8], binocular combinations of monocular corrections were used to correct an individual's vision as a treatment method.

Now, as described in the Application, surprisingly it has been realized that rather than correcting human vision, similar techniques can be used in a new way by intentionally introducing different or the same depths of focus in both eyes, which each of which changes away from a “normal” or typically desired “corrected vision”. It was further realized that the human VR/AR experience can be improved to reduce or substantially eliminate head aches and other physiological discomforts, by intentionally causing a shift away from normal vision, such as, for example, by adding an aberration in both eyes and differently in each eye. The new method and device solves at least in part, and possibly in whole the vergence-accommodation conflict problem. This Application describes the new method and device in an optical approach that reduces the accommodation requirement by extending depth of focus of each of the two eyes differently as a new method to overcome the vergence-accommodation conflict.

Another role of depth of focus is to provide a visual environment where the eye's accommodative response is larger. This modification of depth of focus can make the vergence-accommodation relationship more similar to a natural viewing condition, which reduces mismatch or conflict.

Binocular accommodation response to dissimilar monocular visual inputs is used to characterize binocular vision under unique VR/AR visual environment. Accommodation refers to the ability of the crystalline lens of the human eye to dynamically change focus in order to visualize objects at various distances clearly at the retina. The most widely accepted theory of this focusing mechanism of the eye is that proposed by Hermann von Helmholtz in 1855. When focusing at near objects, the ciliary muscles contract decreasing the equatorial circumlenticular space, which reduces zonular tension and allows the lens to round up leading to an increase in the optical power of the lens. For a distant object, the ciliary muscles relax causing an increase in zonular tension. The increase in zonular tension causes the surfaces of the lens to flatten and the optical power of the lens to decrease. Although a number of studies have investigated fundamental mechanisms of accommodation under normal (natural) viewing condition i.e. both eyes stimulated by the same retinal image quality, no study has been conducted for unique VR/AR visual environment in which the two eyes differ in monocular retinal image quality inputs.

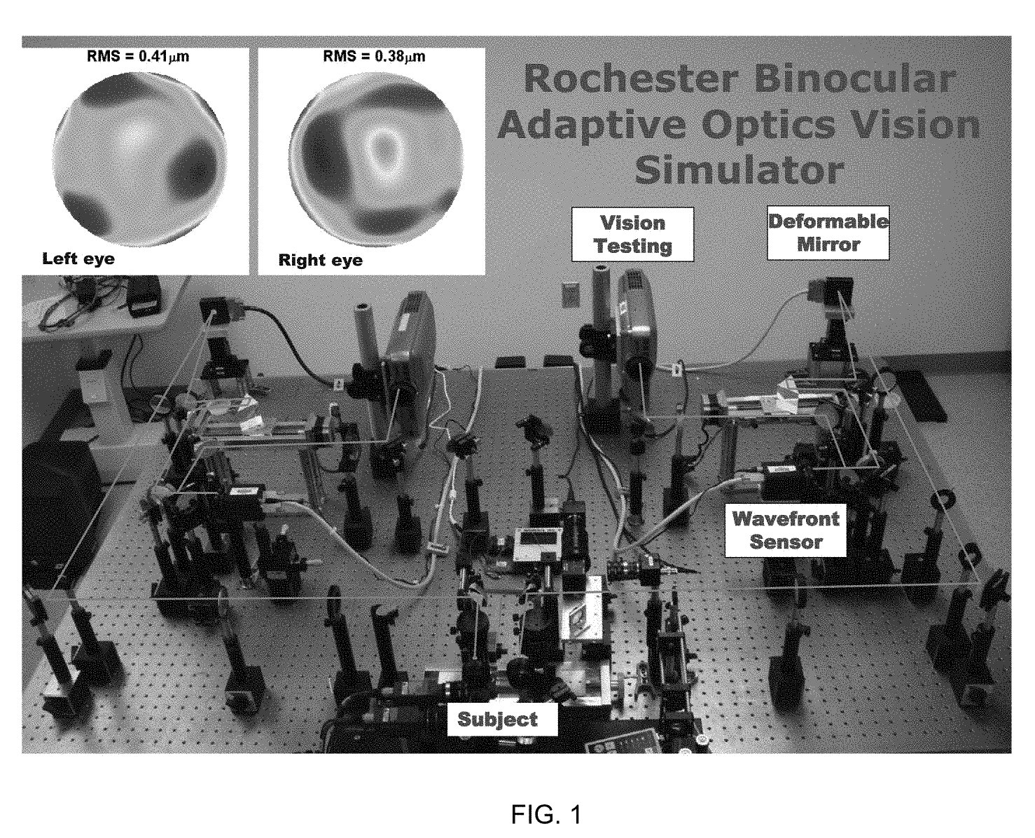

FIG. 1 shows a drawing of one exemplary embodiment of a binocular adaptive optics vision simulator. The binocular adaptive optics vision simulator of FIG. 1 is located at the Advanced Physiological Optics Laboratory, Flaum Eye Institute, The Institute of Optics, Center for Visual Science, Biomedical Engineering at the University of Rochester (assignee of this Application). The binocular adaptive optics vision simulator is an innovative tool to measure and/or control the optics of the two eyes.

It is of scientific and clinical relevance to have the capability to study interactions between aberrations and the neural system, and to be able to assess their impact on visual function. Adaptive Optics (AO) technology makes it possible not only to quantify the optical quality of the eye, but also to correct ocular aberrations noninvasively, providing aberration-free image quality. We developed a binocular AO vision simulator with a sufficiently large dynamic range to enable us to study vision under highly aberrated conditions. With its custom AO control algorithm, our binocular AO simulator can continuously induce aberrations during vision testing, such as including in a closed-loop manner to maintain desired optical quality. The system's fidelity for both optical and psychophysical tasks, including successful testing of binocular function while manipulating ocular optics has been demonstrated. The binocular experiments to test various implementations of the new method and device described herein have been largely performed by use of this apparatus.

### Part 2—Method and Device

As described hereinabove, we realized a solution to the to overcome in part or in whole the vergence-accommodation conflict by a new method and device in an optical approach that reduces the accommodation requirement by extending depth of focus of each of the two eyes the same or differently. Any suitable optical device or techniques, such as, for example, by adding aberrations, can be used to extend the depth of focus of the two eyes. The new method (and device) of the Application describes a new way to provide optical modification devices (e.g. lenses) to intentionally set a same or different increased depth of focus for the eyes of an observer of a VR or AR display screen at about a fixed distance from an observer's eyes.

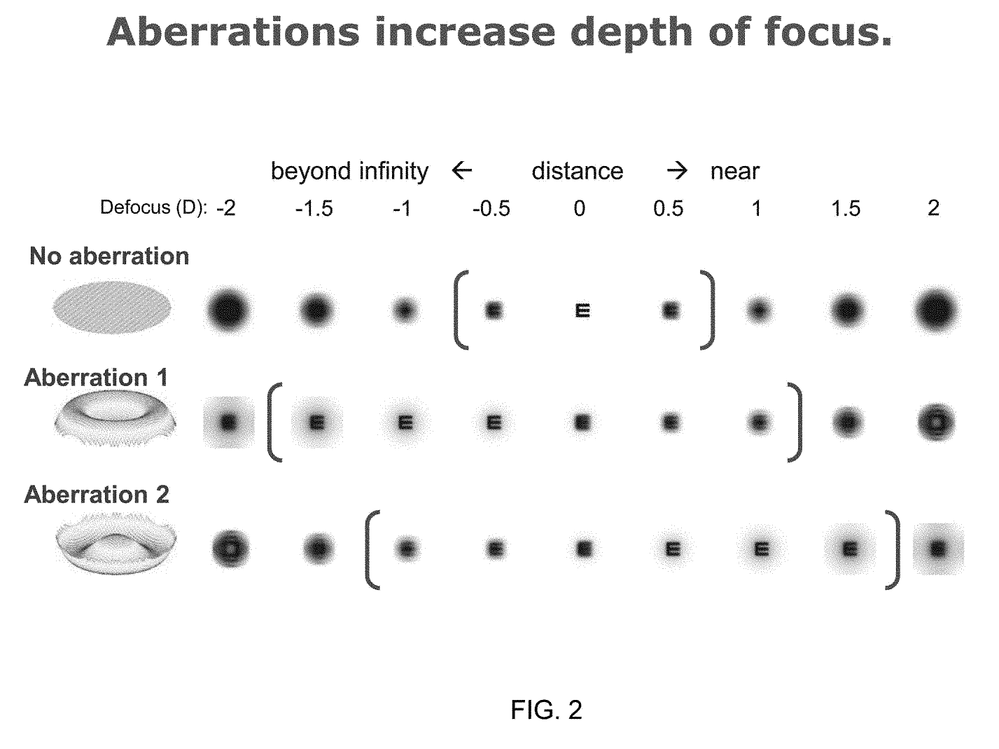

For example, a device to perform the new method could include any suitable optical element to introduce a different depth of focus (e.g. different aberrations) between each of the person's eyes and the VR screen. FIG. 2 is a drawing which shows how a series of eye chart “E” characters which vary in relative distance from beyond infinity to near on a relative D scale from −2 to 2 would appear to an observer's eye. Each character shows a representation of how that character at that virtual distance would appear to the observer. The first line shows a relatively narrow range of focus at a normalized distance of 0, where the E at zero distance is in sharp focus, however the E characters on either side relatively quickly fall off in focus to a complete blur at either end of the scale. The second line shows a first exemplary “aberration 1”, where best focus is at about −0.5 distance, and focus remains relatively good between about −1.5 and 1 (an increased range or depth of focus over the first line). The third line shows a second exemplary “aberration 2”, where best focus is achieved at about 0.5 distance, and there is a useable focus from about −1 to 1.5, a different range of focus than is shown in line 2. Thus, in this first exemplary device, there can be, for example, a first lens between a person's first eye and the VR screen with the aberration properties of FIG. 2, line 2, and a second lens between the person's second eye and the VR screen with the aberration properties of FIG. 2, line 3.

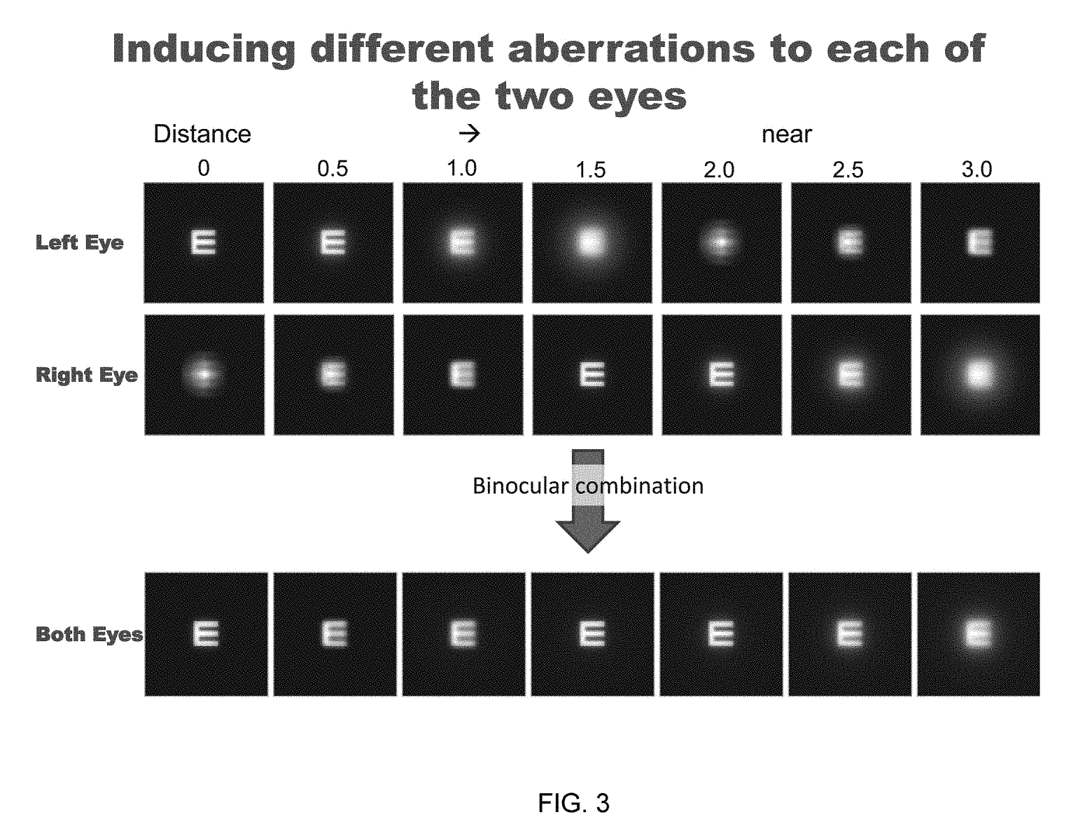

FIG. 3 shows another exemplary drawing of two rows of E type symbols where there is a different depth field for the left eye (first line) and the right eye (second line) by use of any suitable optical device (e.g. lenses). The third line shows the combined image where the viewing person (an observer) wearing a device with two different depths of focus of lines 1 (e.g. left eye) and 2 (e.g. right eye), sees in total, the person's binocular combination. Both eyes see a relatively focused combined image over a range of distance (the binocular combination vision), while each eye has been optimized for a different focal range to maximize the over binocular focal range. Also, by so distributing parts of the focal range between each of the two eyes, there is less stimulation by the brain for accommodation, and therefore less physiological stress for the person using a device to perform the method of the Application.

It is unimportant which eye views the VR screen through which of the two same or different ranges of depth of focus. However, in practice, it can be advantageous to leverage placement of either the right or left correction or aberration to make best use of the individual's uncorrected vision in each eye. Moreover, there can be consideration for which of the person's eyes is the dominant eye (ocular dominance). We previously described an effective technique for quantifying a subjects' degree of ocular dominance [10].

### Part 3—Devices

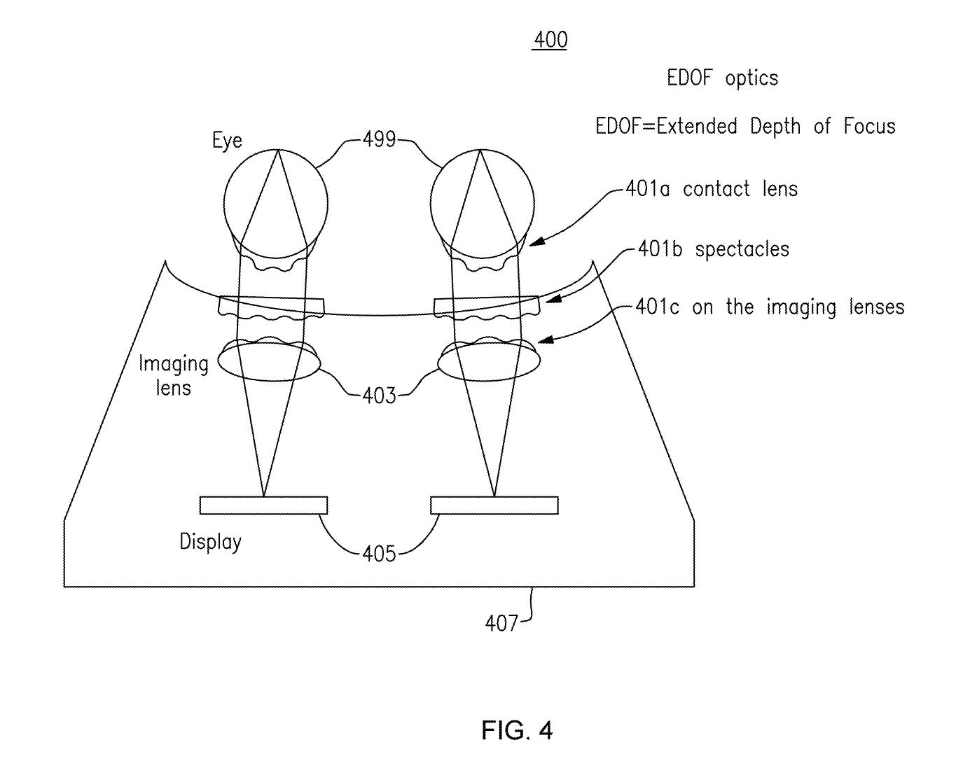

FIG. 4 is a drawing of an exemplary device 400 according to the Application. The exemplary extended depth of focus (EDOF) device is shown as an AR or VR headset which has two displays 405 disposed within a goggle type housing 407. The imaging lenses 403 are of any suitable type for viewing the displays in binocular vision by a user's eyes 499. What makes the device different from those which came before is the addition an EDOF optical element (typically one for each eye) which intentionally causes a larger (extended) depth of field than would have been present by any conventional correction, such as by standard eyewear designed for normal corrective purposes of the prior art. The EDOF optics can be added by, for example, by use of contact lenses, spectacles, or any suitable optical elements (e.g. lenses, gratings, etc.) disposed directly on or manufactured on or into (typically a surface) of the imaging lenses 403. It should be understood that a google implementation is an exemplary device which can carry out the new EDOF methods of the Application. Also, while typically only one of the EDOF optics solutions 401a, 401b, or 401c is used, there can be any suitable combinations thereof to achieve the desired same or different EDOF for the user's eyes. It is unimportant if there are two separate displays (e.g. in an AR or VR goggles), or if there is one wide display which displays two images, one for each eye to observe.

A surprising aspect of the method and device solutions of the Application is that the additional and/or modified optics of the new device is not to correct vision to improve the user's vision towards what has traditionally been viewed as the most desirable correction towards a normal or perfect vision. Rather, the user's vision is intentionally modified away from the previously desired “perfect”, “normal”, or “ideal” vision to a same or different EDOF, which is other than what previously was believed to be the most desirable vision. In most cases, the desired EDOF can be achieved by modifying the vision in both of the right and left eyes (differently or the same) by between about 1.0 Diopter and 4.0 Diopter.

Any suitable optical devices, generally referred to herein as “ocular devices”, can be used to practice the method of providing a different depth of focus for the two different eyes of a person viewing a VR screen. Exemplary suitable ocular devices include one or more lenses (i.e. including compound lenses) placed between each of the person's eyes and the VR screen. Any suitable arrangement which places and optical element such as a lens between each of a viewer's eyes and the VR screen can be used.

Suitable lenses include contact lenses, lenses in eyeglass frames, mounted within any suitable support structure, such as, for example, a mechanical frame, VR goggles, etc. Also, for example, we described customized soft contact lenses related to a method for correcting higher-order aberration (HOA) and improving visual acuity in keratoconic (KC) eyes by use of customized soft contact lenses or phase plates [9, 12]. A scleral lens prosthetic device (SLPD) is another example of a suitable lens which we previously described for correcting ocular higher order aberrations (HOAs) in keratoconus (KC) using wavefront-guided optics [11]. Exemplary suitable methods and systems for manufacturing wavefront-guided scleral lenses (previously intended for vision correction) are also described in U.S. Pat. No. 9,554,889, CUSTOMIZED WAVEFRONT-GUIDED METHODS, SYSTEMS, AND DEVICES TO CORRECT HIGHER-ORDER ABERRATIONS, also assigned to the University of Rochester. Any other suitable optical device type can be used. It not necessary that both the right eye and the left eye's depth of focus be modified by the same type of lenses or optical components. The '889 patent is incorporated herein by reference in its entirety for all purposes.

As described hereinabove a specialized or specialty lens to perform the method includes a lens which can introduce a predetermined amount of spherical aberration. However, any suitable way, such as, for example, including mono-focal, bifocal, and/or multifocal modification structures (e.g. lenses, bifocal lenses, or multifocal lenses) can be used to introduce a certain depth of focus or extend a depth of focus can be used, including any combinations thereof, such as for example, including alternatively, a coma correction (e.g. a comatic aberration). For example, adding a different power (or refractive error correction) to each of the two eyes can be combined with any other suitable methods to extend the depth of focus.

Other suitable ocular devices include, for example, extending the depth of focus by use of a pinhole or a small aperture, such as, for example, a pinhole or a small aperture that can be created on a contact lens. A suitable range for a small aperture is between about 0.5 mm to 3 mm in diameter.

Other suitable ocular devices include, for example, extending the depth of focus by use of a refractive error correction. For example, there can be a refractive error correction to increase the depth of focus for both eyes the same or differently. In another embodiment, there can be a refractive error correction to introduce a near vision for one eye or a far vision for the other eye. However, more generally, the depth of focus for both eyes can be increased either the same or for two different increased depth of focus.

### Part 4—Laboratory Experiments

### Experiment Example 1: Characterization of Binocular Accommodation Response with a Binocular Adaptive Optics (AO) Vision Simulator

Upgrading the Binocular AO vision simulator: A binocular AO vision simulator can be used for low-level visual performance evaluation. Details of the simulator of our exemplary systems have been described in, for example, [6, 13].

AO makes it possible to manipulate ocular aberration (correction or induction) in real-time and perform psychophysical tasks simultaneously. Some of our AO systems include a 97-actuator deformable mirror, a custom-made Shack-Hartmann wavefront sensor, an artificial pupil, visual stimuli for vision testing, and a Badal optometer. The ALPAO 97-actuator deformable mirror (DM97, ALPAO, Saint-Martin-d'Heres, France) is well-suited to studies of the new method and device described hereinabove. An artificial pupil can be placed in the pupil conjugate to accurately control the effective pupil diameter for visual performance test while the maximum pupil diameter is used for running the AO system. The AO system is capable of conducting dynamic accommodation experiment while controlling the optics of both eyes. Ongoing modifications to the AO vision simulator include implementation of a Badal optometer to simulate viewing conditions from infinity (distance) to near up to 4D (25 cm) automatically. Wavefront sensing CCD cameras are being upgraded to have higher sensitivity to infrared laser (λ=980 nm), enabling to increase the wavefront sensing speed up to 30 Hz. Infrared pupil cameras are being implemented to quantify convergence and this convergence measurement will be synchronized with wavefront sensing. Software to generate visual stimuli for psychophysical testing such as stereoscuity is also being developed.

Extending depth of focus of the eyes: Optical theory manifests a multitude of image quality metrics based on aberration information. From the aberration profile of an eye, retinal image quality can be simulated. Although it has been reported that the image quality metrics which best predict subjective judgment of best focus are the area-under-MTF and visual Strehl ratio, the feasibility of these metrics in predicting actual visual performance can be reduced significantly in the presence of higher-order aberrations e.g. spherical aberration and large defocus. Therefore, the correlation coefficient calculated from the perfect and aberrated images after inducing aberrations is being adopted as a new metric. With a robust image quality metric, optimal combinations of spherical aberration inductions can be identified for each of the two eyes. Such optimization can be used as an alternative to empirically measure visual performance with every combination of spherical aberrations with different sign and magnitudes for extending binocular depth of focus, an approach which is less practical. Selection of the best candidates for experimental testing can be based on empirical models. For example, 3 or 4 different spherical aberration profiles for the eyes can be identified and validated by measuring through-focus visual performance i.e. visual acuity, contrast sensitivity and depth of focus under the spherical aberration conditions using the binocular AO vision simulator.

Objective Measurement of Accommodation: A binocular AO vision simulator can also be used to objectively assess subjects' binocular accommodative response. For example, a custom-made Shack-Hartmann wavefront sensor and two IR pupil cameras can be operated simultaneously with a frame rate of 30 Hz. The wavefront sensor can use a near infrared collimated laser diode (λ=980 nm), well outside of the visible spectrum, to avoid any visual competition with the fixation stimulus. The pupils can be illuminated with a near-infrared light-emitting diode (λ=880 nm) and imaged with a wide-field camera. The two pupil images can be analyzed to detect the centers of the pupils and distance between the centers, which provide vergence data. For each frame collected from the wavefront sensor, Zernike coefficients can be computed to convert them into accommodative response. The amplitude of accommodation can be determined by the dioptric location of best focus, or the peak of the through-focus image quality curve. Accommodative error is defined as the dioptric difference between the target vergence (location of the visual stimulus in diopters) and peak image quality. The same measurements can be performed without inducing spherical aberration as by a control condition and the results can be compared with an extended depth of focus case.

### Experiment 2 Example

Stereo performance and subjective symptoms with and without optical manipulation. Contribution of optics to human stereopsis: The contribution of optics to visual acuity and contrast sensitivity is reasonably well understood. We know much less about the optical and neural determinants of stereopsis. Humans can discriminate very small variations in binocular disparity over space, changes that are smaller than foveal photoreceptor diameter. Using an approach similar to that employed in the analysis of the limits of visual acuity and contrast sensitivity, the question of how the eyes' optics affects the precision of stereopsis thereby can be examined. Furthermore, the impact of unevenly manipulated optical quality of the eyes with different spherical aberration on stereoresolution with accommodation can be evaluated. The same or similar simulator and psychophysical procedures as described hereinabove can be used. Stereo resolution can be measured using a corrugation stimulus and stereo acuity using a disparity discrimination task described in Vlaskamp et al. [7]. Stereo resolution can be measured using the finest visible sinusoidal depth corrugation. A random-dot stereogram can be used for the stimulus, such as, for example, as can be created by first generating a hexagonal lattice of high-contrast dots. Then each dot is displaced in random direction by a random distance. The randomized lattice can be copied into the images for the left and right eyes and then horizontally displace the dots in opposite directions in the two images by half the horizontal disparity. With anti-aliasing, very small disparities can be presented. A dichoptic and binocular fixation target is presented between stimulus presentations, so that observers can maintain accurate fixation. The corrugation's orientation is either +10° or −10° from horizontal. Observers indicate after each short presentation which orientation they have seen. By making the corrugations nearly horizontal, we greatly reduce the visibility of monocular artifacts in the stereograms. A cyclopean orientation-discrimination task can be used to assure that observers must perceive some stereoscopically defined spatial structure to perform significantly above chance. The disparity of the corrugation is fixed at a small value to avoid the disparity-gradient limit. The spatial frequency of the corrugation is varied to find the highest visible value.

Measurement of subjective visual symptoms:—Discomfort assessments can be conducted with and without extended depth of focus techniques. A stimulus in which two groups of spatial features can be created which have different disparity i.e. different depth and vary the difference in magnitude and direction in the disparity. Subjects task is to indicate which spatial feature appears nearer in depth than the other and after each session, subjects will be asked to score (1-5, 1 being best) and compare (same, better or worse) their subjective symptoms in terms of headache, eye strain and blurry vision with and without the extended depth of focus techniques.

### Part 5—Traditional Monovision and Modified Monovision

Traditional “monovision” (TMV) is where each of the two eyes is receives a different refractive error correction for far and near vision. Such a traditional monovision approach can be used. However, one problem is that one of the two eyes provides significantly poorer image quality compared to the other eye, which reduces depth perception.

“Modified monovision” (MMV) according to the new devices and method of the Application as described hereinabove is an improved method which extends the depth of focus and can overcome this issue (poorer image quality in one eye, compared to the other eye) because the image quality disparity between the two eyes is reduced by extending depth of focus either the same or differently in both eyes.

### Part 6—Summary

The new method and device of the Application modifies the optical path between each eye of an observer using a VR or AR screen at a fixed distance from the observer for a same or different depth of focus. As described hereinabove, it was realized that rather than correcting the observer's eyesight to a corrected normal vision, the vergence-accommodation conflict can be mitigated by causing an increased depth of focus for both of an observer's eyes (e.g. by modifying an observer's depth of focus by use of ocular devices), or a first depth of focus in a first eye of the observer, and a different second depth of focus in the observer's second eye.

Introduction of a higher order aberration caused by a lens is but one example of how to create the different depths of field between the eyes. Other suitable techniques include pin holes or relatively small apertures, including pin holes or relatively small apertures in contact lenses, and refractive error corrections, such as where one eye is set for a near vision, and the other eye for a far vision.

This method and device describes a completely new way to provide optical modification devices (e.g. lenses) to intentionally set a same or different increased depth of focus for the eyes of an observer of a VR or AR display screen at about a fixed distance from an observer's eyes. The new method and devices to perform the new method are opposite to and counter-intuitive as compared with past work to use some of the same optical components to correct a person's vision where optical components are specified such that both of the person's eyes achieve a corrected normal vision.

### Part 7—Verification

Testing of Binocular accommodative response with extended depth of focus (EDOF) under controlled convergence conditions has been completed with human subjects to verify the new devices and methods of the Application.

Purpose—The vergence-accommodation conflict is one of the main factors causing visual discomfort in virtual/augmented reality. The goal of this study was to investigate binocular accommodative response and visual performance to convergence changes when the two eyes had different extended depth of focus.

Methods—Four normal subjects (26±5 years of age) with at least 2 diopters (D) of accommodative response for 3D of demand were measured. A Maltese cross was presented to stimulate accommodation through a binocular adaptive optics (AO) vision simulator. Three optical conditions were generated: full AO correction (aberration-free), traditional monovision (TMV) with 1.5D of anisometropia and modified monovision (MMV) with additional 4th-order and 6th-order Zernike spherical aberrations. Binocular accommodative responses were measured with different degrees of convergence ranging from 0 to 3D (meter angle) in steps of 1D. Binocular visual acuity and random dot stereoacuity at 0.5, 1.0 and 2.0 c/deg sinusoidal corrugation spatial frequencies were tested.

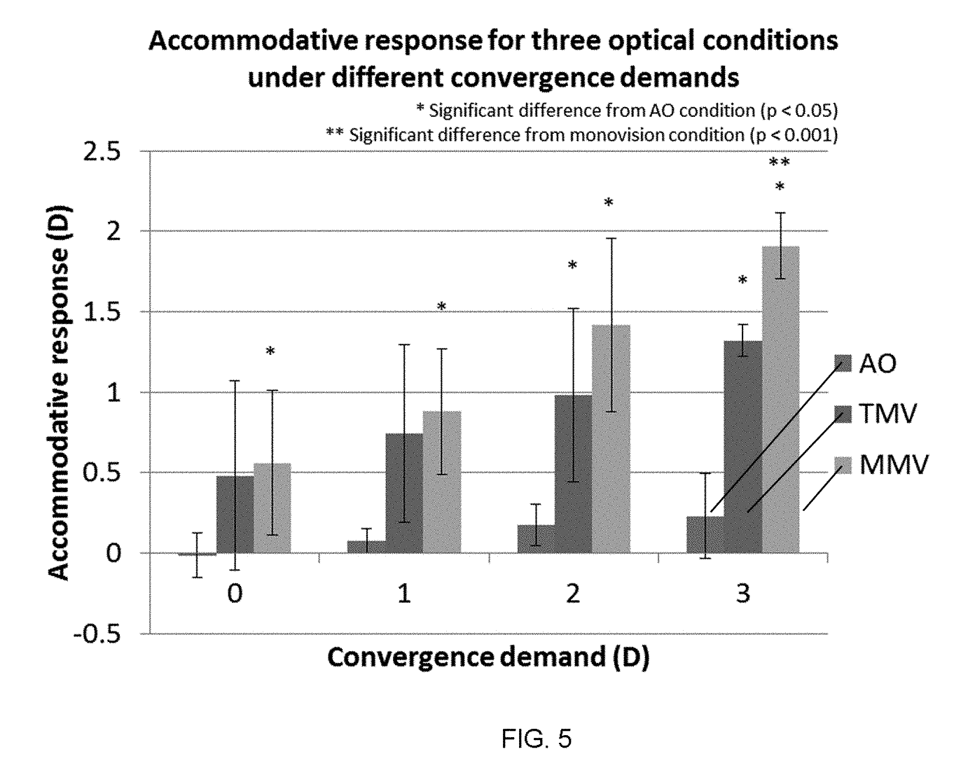

Results—FIG. 5 is a bar graph showing the results of the test and verification experiments of Part 7 of the Application. As can be seen in the bar graph of FIG. 5, both TMV and MMV increased binocular accommodation response compared to the AO condition. The change in average accommodative response at 3D convergence from OD was 0.24±0.21D with AO correction, 0.84±0.51D with TMV and 1.35±0.30D with MMV. Accommodation with MMV was significantly larger than that with TMV (p<0.001). At OD convergence, the average binocular visual acuity in logarithm of the minimum angle of resolution (LogMAR) was −0.18±0.04, −0.15±0.04 and −0.07±0.07 with AO correction, TMV and MMV conditions respectively. MMV degraded visual acuity compared to AO condition (p<0.05) at OD convergence. For all corrugation frequencies at OD convergence, the average stereo detection thresholds in arcmins were 0.52±0.22 with AO correction, 2.1±0.86 with TMV (n=3, one subject was not measurable) and 0.87±0.18 with MMV. Stereoacuity with MMV and AO correction surpassed that with TMV (p<0.05) at both 0 and 3D convergence.

Conclusions—Modified monovision with spherical aberrations increases depth of focus, which allows for larger binocular accommodation changes with convergence, yielding a more natural vergence-accommodation relationship. Although binocular visual acuity and stereoacuity are slightly compromised, the vergence-accommodation conflict in virtual/augmented reality can be alleviated by modified monovision.

Any computer code, including firmware or software, for modeling, designing, or controlling depth of focus type devices can be provided on a non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

### REFERENCES

1. Hoffman, D., Girshick, A., Akeley, K., & Banks, M. (2008). Vergence-accommodation conflicts hinder visual performance and cause visual fatigue. Journal of Vision, 8(3), 33.
2. Fukushima, T., Torii, M., Ukai, K., Wolffsohn, J. S., & Gilmartin, B. (2009). The relationship between CA/C ratio and individual differences in dynamic accommodative responses while viewing stereoscopic images. Journal of Vision, 9(13):21, 1-13, http://www.journalofvision.org/content/9/13/21, doi:10.1167/9.13.21.
3. Akeley, K., Watt, S. J., Girshick, A. R., & Banks, M. S. (2004). A stereo display prototype with multiple focal distances. ACM Transactions on Graphics, 23, 804-813.
4. G. E. Favalora, J. Napoli, D. M. Hall, R. K. Dorval, M. Giovinco, M. J. Richmond, and W. S. Chun, “100-million-voxel volumetric display” in AeroSense (International Society for Optics and Photonics, 2002) pp. 300-312.
5. A. Sullivan, “DepthCube solid-state 3D volumetric display,” Electronic Imaging (2004) pp. 279-284. International Society for Optics and Photonics.
6. Zheleznyak, L., et al., Modified monovision with spherical aberration to improve presbyopic through-focus visual performance. Invest Ophthalmol Vis Sci, 2013. 54(5): p. 3157-65.
7. Vlaskamp, B. N., G. Yoon, and M. S. Banks, Human stereopsis is not limited by the optics of the well-focused eye. J Neurosci, 2011. 31(27): p. 9814-8.
8. Sabesan, Ramkumar, Len Zheleznyak, and Geunyoung Yoon. “Binocular visual performance and summation after correcting higher order aberrations.” Biomedical Optics Express 3.12 (2012): 3176-3189.
9. R. Sabesan, T. Jeong, L. Carvalho, I. Cox, D. Williams, and G. Yoon, “Vision improvement by correcting higher-order aberrations with customized soft contact lenses in keratoconic eyes,” Opt. Lett. 32, 1000-1002 (2007).
10. Len Zheleznyak, Aixa Alarcon, Kevin C. Dieter, Duje Tadin, Geunyoung Yoon; The role of sensory ocular dominance on through-focus visual performance in monovision presbyopia corrections. Journal of Vision 2015; 15(6):17. doi: 10.1167/15.6.17.
11. Sabesan, Ramkumar et al. “Wavefront-Guided Scleral Lens Prosthetic Device for Keratoconus.” Optometry and vision science: official publication of the American Academy of Optometry 90.4 (2013): 314-323. PMC. Web. 1 Feb. 2018.
12. Yoon G, Jeong T, Cox I, Williams D. Vision Improvement by Correcting Higher-order Aberrations With Phase Plates in Normal Eyes. J Refract Surg. 2004; 20: S523-S527. doi: 10.3928/1081-597X-20040901-22.
13. Objective evaluation of through-focus optical performance of presbyopia-correcting intraocular lenses using an optical bench system Kim, Myoung Joon et al. Journal of Cataract & Refractive Surgery, Volume 37, Issue 7, 1305-1312.

What is claimed is:

1. A method for reducing vergence-accommodation conflict comprising: modifying a depth of focus of each of an observer's eyes by use of at least one ocular device to be greater than the observer's uncorrected or corrected vision depth of focus to cause a combined vision from both eyes of the observer to provide a substantially in focus image to the observer of a virtual reality (VR) or augmented reality display (AR) screen at about a fixed distance from the observer.

2. The method of claim 1, wherein said step of modifying comprises modifying a depth of focus of each of an observer's eyes to be greater than the observer's uncorrected or corrected vision depth of focus by between about 1.0 Diopter and 4.0 Diopter.

3. The method of claim 1, wherein said step of modifying comprises modifying a depth of focus of each of an observer's eyes by use of at least one ocular device so that the depth of field is greater than the observer's uncorrected or corrected vision depth of focus to cause a combined vision from both eyes of the observer to provide a vergence-accommodation relationship similar to a natural viewing condition, which reduces at least a mismatch or a conflict.

4. The method of claim 1, wherein said step of modifying a depth of focus comprises the step of modifying a depth of focus of each of an observer's eyes greater than the observer's uncorrected or corrected vision depth of focus by introduction of an aberration.

5. The method of claim 4, wherein said introduction of an aberration comprises an introduction of a spherical refractive error or a cylindrical refractive error.

6. The method of claim 4, wherein said introduction of an aberration comprises an introduction of a higher order aberration or a multifocal modification.

7. The method of claim 4, wherein said introduction of an aberration comprises a pin hole or a small aperture between about 0.5 mm to 3 mm in diameter.

8. The method of claim 1, wherein said step of modifying a depth of focus comprises the step of modifying a depth of focus of each of an observer's eyes greater than the observer's uncorrected or corrected vision depth of focus by introduction of a refractive error correction.

9. The method of claim 8, wherein said refractive error correction comprises a near vision correction for one eye, and a far vision correction for a different eye.

10. A device for reducing vergence-accommodation conflict comprising:
a support structure adapted to house a virtual reality (VR) or augmented reality display (AR) display screen at a distance from an observer's first and second eyes;
a first ocular device adapted to cause a first extended depth of focus between the first eye of an observer and the display screen, said first ocular device physically attached to said support structure or adapted to be worn by an observer as a contact lens or as a first lens of an eyeglass frame;
a second ocular device adapted to cause a second extended depth of focus between the second eye of an observer and the display screen, said second ocular device physically attached to said support structure or adapted to be worn by an observer as a contact lens or as a first lens of an eyeglass frame; and
wherein a combined vision from both eyes of the observer provides a substantially in focus image to the observer of said display screen at about a fixed distance from the observer.

11. The device of claim 10, wherein said first extended depth of focus and said second extended depth of focus are greater than the observer's uncorrected or the observer's corrected vision depth of focus by between about 1.0 Diopter and 4.0 Diopter.

12. The device of claim 10, wherein said support structure comprises a virtual reality wearable body or an augmented reality wearable body.

13. The device of claim 10, wherein said support structure comprises a goggles body adapted to fit an observer's face.

14. The device of claim 10, wherein at least one of said first ocular device or said second ocular device comprises a spherical aberration correction.

15. The device of claim 10, wherein at least one of said first ocular device or said second ocular device comprises a lens for correcting an ocular higher order aberration (HOA).

16. The device of claim 10, wherein at least one of said first ocular device or said second ocular device comprises an optical lens.

17. The device of claim 10, wherein at least one of said first ocular device or said second ocular device comprises a wavefront-guided scleral lens.

18. The device of claim 10, wherein at least one of said first ocular device or said second ocular device comprises a scleral lens prosthetic device (SLPD).

19. The device of claim 10, wherein at least one of said first ocular device or said second ocular device comprises a contact lens or a soft contact lens.

20. The device of claim 10, wherein at least one of said first ocular device or said second ocular device comprises a contact lens or a soft contact lens.

21. The device of claim 10, wherein at least one of said contact lens or a soft contact lens comprises a pin hole a small aperture between about 0.5 mm to 3 mm in diameter.

22. The device of claim 10, wherein said first ocular device and said second ocular device comprise a right and left lens of an eyeglass frame.
